(19) United States
(12) Patent Application Publication
(10) Pub. No.: US 2019/0226995 A1
(43) Pub. Date: Jul. 25, 2019

(54) SPECTROSCOPY APPARATUS AND METHODS

(71) Applicant: RENISHAW PLC, Wotton-under-Edge (GB)

(72) Inventor: Thomas Anthony MASON, Yatton (GB)

(73) Assignee: RENISHAW PLC, Wotton-under-Edge (GB)

(21) Appl. No.: 16/373,762

(22) Filed: Apr. 3, 2019

Related U.S. Application Data
(62) Division of application No. 15/025,464, filed on Mar. 28, 2016.

(30) Foreign Application Priority Data
Oct. 2, 2013 (GB) 1317429.7

(51) Int. Cl. G01N 21/65; G01J 3/02; G01J 3/28; G01J 3/44

(52) U.S. Cl. CPC G01N 21/65; G01J 3/0248; G01J 3/2823; G01J 3/44; G01J 3/2803; G01J 3/0237; G01N 2201/122; G01N 2201/103; G01N 2201/11; G01J 2003/2826; G01N 2201/117; G01N 2201/025; G01N 2201/06113; G01J 3/0208

(57) ABSTRACT

This invention concerns spectroscopy apparatus comprising a light source arranged to generate a light profile on a sample, a photodetector having at least one photodetector element for detecting characteristic light generated from interaction of the sample with light from the light source, a support for supporting the sample, the support movable relative to the light profile, and a processing unit. The processing unit is arranged to associate a spectral value recorded by the photodetector element at a particular time with a point on the sample predicted to have generated the characteristic light recorded by the photodetector element at the particular time based on. relative motion anticipated to have occurred between the support and the light profile.

This application is a divisional of U.S. patent application Ser. No. 15/025,464 filed on Mar. 28, 2016, which in turn is a National Stage of International Patent Application PCT/GB2014/052937 filed Sep. 30, 2014, which claims the benefit of Great Britain Patent Application No. 1317429.7 filed on Oct. 2, 2013. The disclosure of each of the prior applications is incorporated herein by reference in their entirety.

### FIELD OF THE INVENTION

This invention relates to spectroscopy apparatus and methods. It is particularly useful in Raman spectroscopy, though it can equally be used in other forms of spectroscopy, e.g. using fluorescence, narrow-line photoluminescence or cathodoluminescence.

### BACKGROUND

An example of Raman spectroscopic apparatus is shown in U.S. Pat. No. 5,442,438 (Batchelder et al). Light from a laser source is focussed to a spot on a sample. Interaction between the light and the molecules of the sample causes Raman scattering into a spectrum having frequencies and wavenumbers which are shifted relative to the exciting laser frequency. After filtering out the laser frequency, a dispersive device such as a diffraction grating disperses this scattered Raman spectrum across a two-dimensional photodetector array, e.g. in the form of a charge-coupled device (CCD). Different molecular species have different characteristic Raman spectra, and so the effect can be used to analyse the molecular species present. The Raman spectrum can also give other information, such as the local stresses or strains in the sample.

If it is desired to map an area of the sample, rather than just a single point, then it is known to mount the sample on a stage which can be moved in orthogonal directions X, Y. Alternatively, movable mirrors may deflect the light beam across the surface of the sample in X and Y directions. Thus, a raster scan of the sample can take place, giving Raman spectra at each point in the scan.

At each point in such a raster scan, the laser beam must illuminate the sample for a sufficient length of time to allow a Raman spectrum to be acquired. Obtaining a map over a large area of the sample can therefore be time consuming It is therefore known to illuminate the sample not with a point focus, but with a line focus. This enables the acquisition of spectra from multiple points within the line simultaneously. On the CCD photodetector, it is arranged that an image of the line extends orthogonally to the direction of spectral dispersion. This enables efficient use of the two-dimensional nature of the photodetector to acquire the multiple spectra simultaneously. The multiple spectra are formed simultaneously in multiple rows or columns of the CCD array.

U.S. Pat. No. 8,179,526 describes a method wherein charge on the CCD array is shifted between elements of the array synchronously with movement of the sample relative to the line focus. The shift of charge may be in a direction perpendicular to the direction of spectral dispersion. Accordingly, points are illuminated successively by light from different positions along the length of the line focus ensuring that each point is illuminated by the same total intensity of light even if the light intensity varies along the length of the line focus.

In an implementation of the method described in U.S. Pat. No. 8,179,526, a motor that drives movement of the stage on which the sample is mounted is under the control of a stage controller separate from the controller that controls shifting of the charge between elements of the CCD array. Before a spectrum is recorded for a particular target position of the sample, a target position is sent to the stage controller, which activates the motor to drive the stage to the target position. The controller controlling the CCD array activates the CCD array to record a spectrum after a given time period has passed from sending of the target position to the stage controller.

A problem with this arrangement is that, for high data collection rates, the position of the stage may lag behind the target position by some distance when the spectrum is recorded, resulting in inaccuracies in the recorded position for a spectrum.

FIG. 1 is graph showing the inaccuracies in position and variations in velocity. The graph is for a data collection rate of 77 rows of the CCD array in 1.08 ms. The dotted and dashed line shows the expected position of the stage, whereas the dotted line (with long dots) shows the actual position of the stage and how it lags the expected position. Point 1 is the final time data is recorded by the CCD and point 2 and 3 the actual and expected positions of the table, respectively, at this time. From the average velocity, indicated by the dotted line with small dots, it can be seen that the velocity of the stage varies throughout the period in which data is recorded by the CCD array.

### SUMMARY OF THE INVENTION

According to a first aspect of the invention there is provided spectroscopy apparatus comprising;
a light source for generating a light profile on a sample;
a photodetector having at least one photodetector element for detecting characteristic light generated from interaction of the sample with light from the light source;
a support for supporting the sample, the support movable relative to the light profile; and
a processing unit arranged to associate a spectral value recorded by the photodetector element at a particular time with a point on the sample predicted to have generated the characteristic light recorded by the photodetector element at the particular time based on relative motion anticipated to have occurred between the support and the light profile.

In this way, the rate at which data is recorded by the photodetector is not limited by the speed of communications between the photodetector and a controller for controlling relative movement of the support to the light profile, such as a spot, line focus or other suitable pattern of light. In particular, the processing unit may associate spectral values with points on the sample based on information on the relative position of the support to the light profile that may have been obtained at a time other than the time at which the spectral value was recorded.

The characteristic light may be light scattered from the sample, such as light generated by Raman. scattering.

The photodetector can be activated based on relative motion of the support to the light profile predicted from a previous known position. For example, the support can be set in motion and. the photodetector arranged to record spectral values at intervals thereafter based on anticipated motion of the support.

The apparatus may comprise a motor for driving movement of the support relative to the light profile. The motor may be controlled to provide predetermined motion of the support relative to the light profile.

Movement of the support relative to the light profile during a measuring period may be at a constant velocity, the processing unit arranged for controlling the photodetector such that the photodetector element records spectral values at equally spaced time intervals during the measuring period. The support and/or light profile may be accelerated. up to the constant velocity during an acceleration period, the processing period arranged to control the photodetector to begin recording spectral values for the characteristic light at the end of the acceleration period. An initial point to be sampled may be identified and the support and/or light profile may be set in motion from a position that is set back from an intercept position in which the initial point is illuminated by the light profile to generate characteristic light on the photodetector element such that the acceleration period has ended by the time the initial point is in the intercept position.

The processing unit may be arranged to extrapolate, from a known relative position of the support to the light profile at a known time, the time at which the point is illuminated by the light profile to generate characteristic light that falls on the photodetector element. A spectral value recorded at this time can then be correlated with the point on the sample. For high data collection rates, it may not be possible to determine and communicate the relative position of the support to the light profile at a sufficiently high speed to provide timely information that a given point is illuminated by the light profile. The invention may allow the photodetector to record spectral values at a higher data rate than the rate at which relative positions of the support to the light profile can be detected and communicated.

Relative positions of the support to the light profile may be extrapolated from a known motion of the support relative to the light profile from the known position. For example, it may be assumed that the support travels at a constant velocity relative to the light profile from the known position.

The apparatus may comprise a sensor for detecting positions of the support. The processing unit may be arranged to extrapolate from the detected positions, the point on the sample that generates characteristic light recorded by the photodetector element at a given time. The processing unit may be arranged to determine velocity, and optionally, acceleration of the support from the detected positions. The processing unit may be arranged to update a time for initiating the photodetector based upon the determined velocity and, optionally, acceleration. The processing unit may be arranged to update a time for initiating the photodetector based upon the detected position, for example if the photodetector is to be initiated When a predetermined point on the sample is illuminated by the light source to generate characteristic light on the photodetector element. However, it will be understood that the photodetector could be initiated at a time when the motion of the support meets specified velocity or acceleration criteria, such as constant velocity, independent of the point on the sample that generates characteristic light on the photodetector element at this time.

A sampling time interval during which the photodetector element records the spectral value, for example, by accumulating charge, (before the spectral value is shifted or read from the photodetector element) may be shorter than a detection time interval between which detected positions of the support are reported to the processing unit. Accordingly, a data rate at which the photodetector element records spectral values for points on the sample (such as a continuum of points) may be greater than the data rate for recording detected positions of the support.

The photodetector may comprise a photodetector timer, the photodetector element arranged to record spectral values based upon signals from the photodetector timer. The photodetector timer may be initiated at a time the support is predicted to be at a predetermined position relative to the light profile based upon detected positions from the sensor. The motion of the support relative to the light profile may be arranged such that the support is moving at a constant velocity relative to the light profile when the support is at the predetermined position. The predetermined position may be the intercept position.

The motor speed of the motor that drives the support may be controlled based upon a support timer. The support timer may be the same or a different timer to the photodetector timer.

The processing unit may be arranged to control relative movement of the support to the light profile such that the light profile commences a scan of the sample from a position in which an initial point to be sampled is spaced from the light profile. In this way, the support and/or light profile can be accelerated to a required, possibly constant, velocity before the initial point is intercepted by the light profile. The support and/or light profile may have a preset rate of acceleration and the distance the initial point is spaced from the light profile may be determined based on the preset acceleration and a target velocity at which sampling is to take place selected by the user. The target velocity may be selected directly or indirectly, for example by the user selecting a data collection rate.

According to a second aspect of the invention there is provided a method of carrying out spectroscopy on a sample comprising:
moving the sample relative to a light profile that illuminates the sample to successively illuminate a plurality of points on the sample;
detecting, with a photodetector element of a photodetector, characteristic light generated from the points through interaction of the sample with light forming the light profile; and
associating a spectral value recorded by the photodetector element at a particular time with a point on the sample predicted to have generated the characteristic light recorded by the photodetector element at the particular time based on relative motion anticipated to have occurred between the support and the light profile.

According to a third aspect of the invention there is provided a data carrier having instructions stored thereon, which, when executed by a processing unit of a spectroscopy apparatus according to the first aspect of the invention, cause the processing unit to carry out the method of the second aspect of the invention.

According to a fourth aspect of theinvention there is provided spectroscopy apparatus comprising:
a light source arranged for generating a light profile on a sample;
a photodetector having at least one photodetector element for detecting characteristic light generated from interaction of the sample with light from the light source;
a support for supporting the sample, the support movable relative to the light profile; and
a processing unit for controlling movement of the support, wherein the processing unit is arranged to receive a selection of an area of the sample to be scanned with the light profile and accelerate the support to a predetermined velocity from a position such that the support has reached the predetermined velocity when the light profile intercepts the area to be scanned.

The processing unit may be arranged to control. relative movement of the support to the light profile such that light profile is scanned over the area at a constant velocity.

According to a fifth aspect of the invention there is provided a method of carrying out spectroscopy on a sample comprising:
receiving a selection of an area of a sample to be scanned;
moving the sample relative to a light profile generated on the sample by a light source to successively illuminate a plurality of points in the area of the sample;
detecting, with a photodetector element of a photodetector, characteristic light generated from the points through interaction of sample with light forming the light profile;
wherein the sample is accelerated to a predetermined velocity from a position such that the sample has reached the predetermined velocity when the light profile intercepts the area to be scanned.

According to a sixth aspect of the invention there is provided a data carrier having instructions stored thereon, which, when executed by a processing unit of a spectroscopy apparatus according to the fourth aspect of the invention, cause the processing unit to carry out the method of the fifth aspect of the invention.

According to a seventh aspect of the invention there is provided spectroscopy apparatus comprising:
a light source arranged for generating a light profile on a sample;
a photodetector comprising a plurality of photodetector elements for detecting characteristic light generated from interaction of the sample with light from the light source, the photodetector elements arranged in at least one row or column;
a support for supporting the sample, the support movable relative to the light profile; and
a processing unit arranged for initiating the photodetector when the support is moving at a predetermined constant velocity relative to the light profile such that the photodetector elements record data for characteristic light, wherein data is shifted repeatedly between the photodetector elements of the at least one row or column, each successive shift occurring after an equal time interval from a previous shift.

In this way, synchronizing communications between the photodetector and the controller/motors that generate relative movement between the support and the light profile, which may impose limits on a data collection rate, may not be required after activation. In particular, the equal time interval may be preset based upon a preset constant velocity. For example, the constant velocity and interval at which the data is shifted may be selected such that data recorded for characteristic light from a given point or region of the sample accumulates in successive photodetector elements of the at least one row or column as the data is shifted along the row or column.

The constant velocity may be preselected based upon a desired exposure time and a distance on the sample that corresponds to a height of one photodetector element. The constant velocity may also be preselected based upon a length of the light profile, such as a length of a line focus.

According to an eighth aspect of the invention there is provided a method of carrying out spectroscopy on a sample comprising:
moving a sample relative to a light profile generated on the sample by a light source to successively illuminate a plurality of points in the area of the sample such that characteristic light generated from the plurality of points through interaction of the sample with light forming the light profile falls on a plurality of photodetector elements of a photodetector, the plurality of photodetector elements arranged in at least one row or column; and
activating the photodetector when the support is moving at a predetermined constant velocity relative to the light profile such that the photodetector elements record data for the characteristic light, wherein data is shifted repeatedly between the photodetector elements of the at least one row or column, each successive shift occurring after an equal time interval from a previous shift.

According to a ninth aspect of the invention there is provided a data carrier having instructions stored thereon, which, when executed by a processing unit of a spectroscopy apparatus according to the seventh aspect of the invention, cause the processing unit to carry out the method of the eighth aspect of the invention.

The data carrier of the above aspects of the invention may be a suitable medium for providing a machine with instructions such as non-transient data carrier, for example a floppy disk, a CD ROM, a DVD ROM RAM (including −R/−RW and +R/+RW), an. HD DVD, a Blu Ray(™) disc, a memory (such as a Memory Stick(™), an SD card, a compact flash card, or the like), a disc drive (such as a hard disc drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF THE DRAWINGS

FIG. 1 is a graph showing the position and velocity of a stage of a prior art spectroscopy apparatus as a sample is scanned;

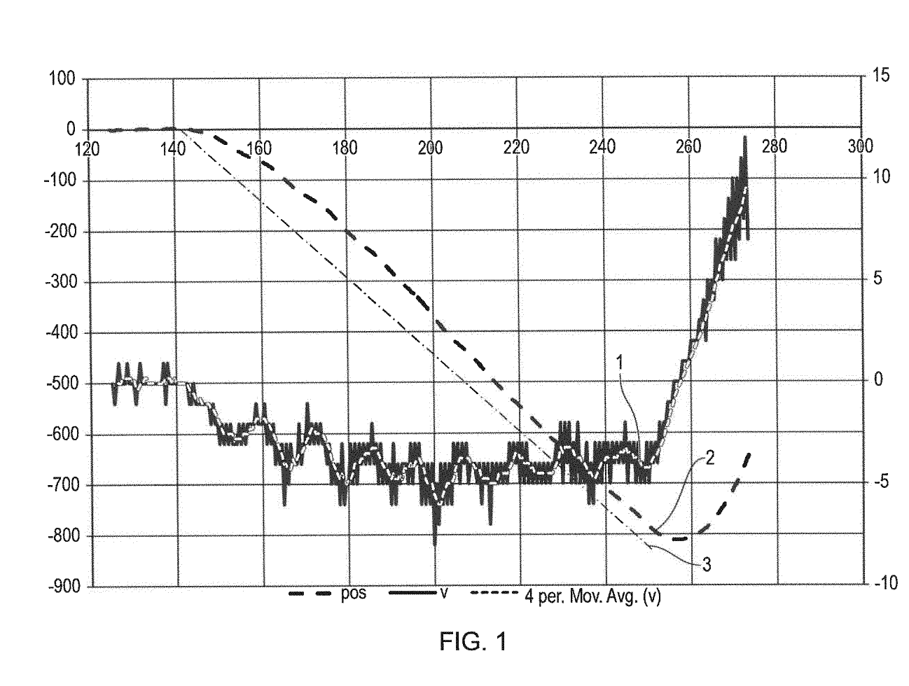

FIG. 2 is a schematic view of Raman spectroscopy apparatus according to an embodiment of the invention;

FIG. 3 shows a line focus generated by the Raman spectroscopy apparatus moving relative to a sample and a corresponding shift of charge within a CCD photodetector; and

FIG. 4 is a graph showing the position and velocity of a stage as a sample is scanned for spectroscopy apparatus according to the invention.

### DESCRIPTION OF EMBODIMENTS

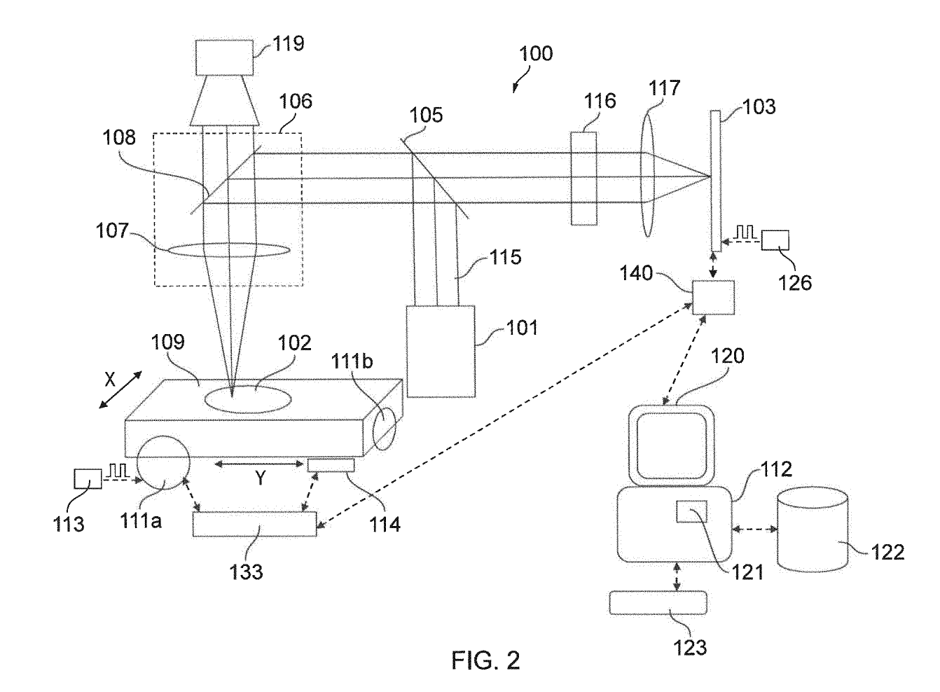

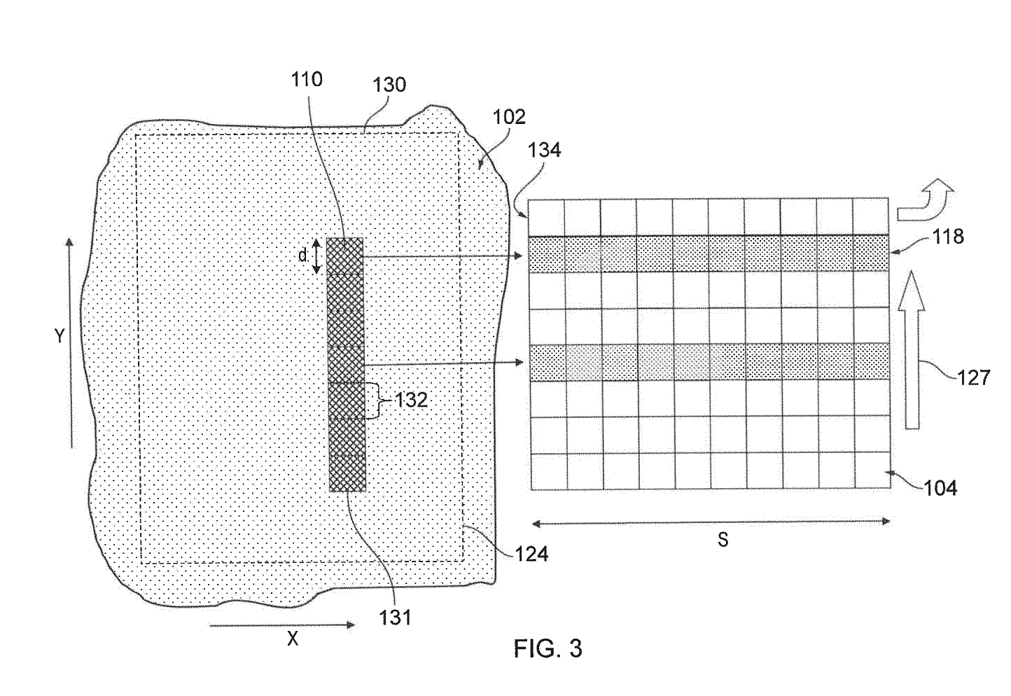

Referring to FIGS. 2 and 3, a Raman spectroscopy apparatus 100 comprises a light source 101 arranged for generating a light profile 110 for illuminating a sample 102 and a photodetector 103 having a plurality of photodetector elements 104 for detecting light scattered from the sample 102.

The light source 101 comprises a laser, beam expander and suitable lenses and mirrors (not shown) for shaping and directing a laser beam 115 onto filter 105, which reflects light at the laser frequency/wavenumber but transmits light at other frequencies/wavenumbers. The filter 105 directs the laser beam 115 onto a microscope 106. In the microscope 106, the laser beam 115 is directed through an objective lens 107 via one or more suitable mirrors 108 to focus the laser beam 115, in this embodiment as the line focus 110, onto the sample 102 supported on a movable stage 109. The optical arrangement is similar to that described in U.S. Pat. No. 5,442,438 and WO2008/090350, which are incorporated herein by reference.

The stage 109 is movable to move the sample 102 relative to the line focus 110 in perpendicular directions X and Y. Motors 111a, 111b are provided for driving motion of the stage 109 in each direction. Movement of the motor 111a, 111b may be under control of a controller 133 and regulated by a timer 113. A sensor 114 detects a position of the stage 109. In this embodiment, the sensor 114 comprises an encoder scale and corresponding read-head mounted on relatively movable elements of the stage 109. The stage controller 133 is arranged for communicating with computer 112.

Illumination of the sample 102 by the laser beam 115 generates scattered light, e.g. Raman scattered light, at different frequencies/wavenumbers to the laser frequency/wavenumber. The scattered light is collected by the microscope objective lens 107 and directed towards the photodetector 103. The scattered light passes through filter 105 and an optical element 116, such as a diffraction grating, for spectrally dispersing the scattered light across the photodetector 103. The spectrally dispersed light is focused onto the photodetector 103 by a focussing lens 117.

In this embodiment, the photodetector 103 is a charge coupled device (CCD) comprising a two-dimensional array of photodetector elements 104. However, other detectors are possible, such as a two-dimensional CMOS photodetector array. The diffraction grating disperses the spectrum of scattered light across the surface of the CCD 103 in a direction S. For each position of the line focus 110 on the sample 102, the scattered light that is dispersed across one row 118 of photodetector elements 104 originates from a region or site on the sample 102.

The photodetector 103 comprises a processor 140, which controls the charge coupled device. The processor 140 is arranged to communicate, such as via a USB bus, with computer 112 and through a further communication line, such as a serial communication bus, with stage controller 133. The processor 140 and photodetector array 103 may be built as a single unit.

A camera 119 is mounted such that an image of the sample 102 can be captured by the camera 119 through the same objective lens 107 of the microscope 106 that is used to focus the laser beam 115 onto the sample 102. Images captured by the camera 119 are sent to computer 112 and may be displayed on display 120.

Computer 112 comprises a processing unit 121 that executes instructions in computer programs stored in memory 122. As will now be described, the computer 11.2, processor 140 and stage controller 133 control movement of the stage and shifting and reading of charge in the CCD 103 to raster scan the line focus 110 across the sample 102 and record spectral values for light scattered from the sample. However, it will be understood that, in other embodiments, other combinations of processors and distributions of processing may be used.

Initially, a user places a sample 102 on the movable stage 109 and captures an image of the sample using camera 119. This image is displayed on display 120 and the user can use an input device 123, such as a keyboard or pointing device, to select an area 124 of the sample 102 to be scanned using the line focus 110. The system has been calibrated such that each pixel of the image corresponds to a known location on the stage. Accordingly, the processing unit 121 can determine from the area 124 identified in the image the movement of the stage 109 that is required to scan this area of the sample 102 using the line focus 110,

During configuration, the user requests an exposure time for regions to be sampled. The processing unit 121 calculates a desired velocity of the stage 109 during sampling by dividing the requested exposure time by the number of exposed rows 118 on the CCD 103 multiplied by a distance, d, at the stage 109 that corresponds to the height of a single row 118 on the CCD 103. This velocity may be rounded into whole units that are accepted by the stage controller 133. For example, an integer number of 10 s of motor steps per second.

The processing unit 121 then calculates, from the desired velocity, a required shift delay (sampling period) between shifts of charge between rows 118 of the CCD 103 such that the motion of the stage 109 and shifting of the charge is synchronized. For example, the required shift delay may be determined from the distance, d, at the stage 109 that corresponds to the height of a single row 118 on the CCD 103 divided by the desired velocity.

The processing unit 121 configures the stage controller 133 via processor 140 to control the motor 111a such that the stage 109 accelerates at a pre-set constant rate, Such a configuration may occur before or after the above calculations of desired velocity and shift delay.

For movement of stage 109 in the Y direction, leading edge 131 of the line focus 110 is initially setback by a distance from an edge 130 of the area 124. A distance the line focus 110 is setback is determined such that the stage 109 can be accelerated to the desired velocity before the line focus 110 intercepts the edge of area 124. To determine the setback distance, the processor 121 determines an acceleration distance the stage 109 would have to travel to reach the desired velocity (from being stationary) when accelerating at the preset constant rate. The setback distance is calculated by adding to the acceleration distance, an additional distance to allow a set period, in this embodiment 20ms, during which the stage 109 should be travelling at a constant velocity. This additional distance gives some leeway and allows a period of time in which the processing unit 121 can measure a position of stage 109 and determine a time at which the leading edge 131 the line focus 110 will intercept the edge 130 of area 124, as described in more detail below.

From the setback distance and the knowni location of area 124, a start position can be determined. A stop position is a position in which the line focus 110 is outside area 124, the stop position giving the stage 109 adequate distance to slow down after the line focus 110 leaves area 124.

The processing unit 121 sends commands to controller 140 specifying the start and stop positions for the stage 109 and the desired velocity for the stage 109 and instructions to carry out the processing as described below. On receiving an initiation command from computer 112, the processor 140 sends the start and stop positions and desired velocity to the stage controller 133 and executes the commands for controlling the photodetector 103.

On receiving the start and stop positions, the stage controller 133 activates motors 111a, 111b to drive the stage to the start position.

After reaching the start position, the stage 109 is accelerated in the Y-direction up to the desired velocity. The stage controller 133 uses clock pulses from the timer 113 to regulate the speed of the motor 111a such that the motor 111a maintains a set velocity once the desired velocity has been reached.

During this acceleration period, signals from sensor 114 are sent to processor 140 and the processor 140 records position data on the changes in position of the stage 109 with time. From the position data., the processor 140 predicts when the line focus 110 will intercept an edge 130 of the area. This prediction is updated as new data is received from the sensor 114.

The position data may be collected through the processor 140 repeatedly interrogating the stage controller 133 during the acceleration period. The processor 140 stores a first clock count, t₁, from an internal timer (not shown) and sends a signal to the stage controller 133 requesting a position of stage 109. In response to receiving the request, the stage controller 133 obtains a reading from sensor 114 and returns this reading to processor 140. On receiving the reading, the processor 140 stores a second clock count, t₂. The processor 140 records the reading as occurring at a time (t₁+t₂)/2. This is based on the assumption that transmit and receive phases take an equal time.

From the position data, the processor 140 calculates an. average velocity and acceleration over a predefined period, such as 3 readings. The time that a leading edge 131. of the line focus 110 is predicted to intercept area 124 is updated based on the determined velocity and acceleration.

The processor 140 activates the CCD 103 to commence a measurement period at a time the leading edge 131 of the line focus 110 is predicted to have intercepted the edge 130 of the area 124. This may comprise activating timer 126, which regulates the rate at which charge is shifted on the CCD 103. Charge is shifted from each row to an adjacent row in the direction indicated by arrow 127 at equally spaced time intervals corresponding to the calculated shift delay. Accordingly, charge is shifted along the CCD 103 synchronously with movement of the line focus 110 across the area 124 to be sampled.

FIG. 3 shows part of area 124 of sample 102 illuminated by the line focus 110. Y shows the direction of movement of the stage 109 and. arrow 127 the direction that charge is shifted on the CCD array 103. For each region 132 (hereinafter referred to as a point) on the line focus 110, a Raman spectrum (indicated by the shaded area) is dispersed in direction S, perpendicular to direction Y, along a corresponding row 118 of the CCD photodetector 103, It should be understood that the size of the points 132 have been exaggerated in FIG. 3 and in reality there are many more times this number of points and many more times this number of rows 118 on the CCD 103.

The exposure of the CCD 103 to light results in the accumulation of charge in each photodetector element 104. This charge represents a spectral value (or bin) for the Raman spectrum and is in proportion to the amount of light it has received during the exposure. The sample 102 moves continuously relative to the line focus 110 such that the light that is incident on any one photodetector element 104 between shifts in the charge is scattered light originating from a region in the sample that is longer than the point 132 on the line focus 110. Accordingly, adjacent rows of the photodetector 103 will sample overlapping regions of the sample 102.

The charge is shifted between the rows of the CCD 103 in direction 127, with charge steadily accumulating for scattered light originating from a given region on the sample 103 in successive photodetector elements 104 in the direction that the charge is shifted. The shifting of charge continues until the charge is shifted into readout register 134. The charge in readout register 134 is read out to processor 140. Thus, between shifts in the charge on the CCD 103, the shift register 134 holds data for one complete spectrum that has accumulated from illumination of a given region of the sample 102 as that given region was moved through the line focus 110.

The processor 1.40 sends the spectral readout from the CCD 103 to processing unit 121. The processor 140 continues to receive position data based on the signals from sensor 114 throughout the scanning of area 124 with the line focus 110 and these may also be passed to computer 112.

From the position data, the processing unit 121 of computer 112 can determine a position of the stage 109 at a given time. However, the rate at Which data is accumulated by the CCD 103 is faster than the rate at Which position data is received from the sensor 114. For example, the sampling time interval for which charge is accumulated in a detector element 104 is shorter than a detection time interval between position measurements being sent to processor 140. Accordingly, the processing unit 121 associates a complete spectrum read-out from readout register 134 at a particular time with a region on the sample predicted to have generated the scattered light based on relative motion anticipated to have occurred between the stage 109 and the line focus 110. This can be determined from the known constant velocity at which the stage 109 is travelling and the time at which the line focus 110 was predicted to have intercepted the area 124. However, preferably, the processing unit 121 also extrapolates from the position data received during scanning, a region on the sample 102 predicted to have generated the Raman spectrum.

The above process may be repeated for different X positions so that the line focus 110 scans the entire area 124 of the sample 102.

A map can then be formed associating the recorded spectra with a spatial distribution based on the regions of the sample that are predicted to have generated the spectra. A map may be formed for a particular element of the spectra, such as a particular wavenumber at which a Raman peak occurs for a particular molecular species.

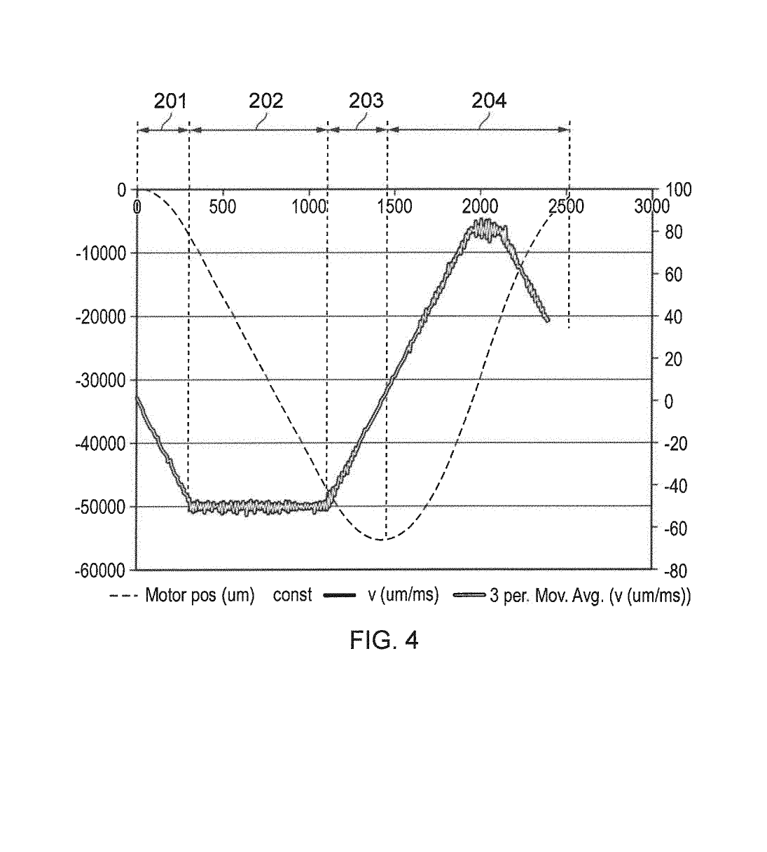

FIG. 4 illustrates the different periods of the motion of stage 109 comprising an acceleration period 201, a constant velocity period 202, a slow down period 203 and a return period 204 in which the stage 109 returns to a start position to scan the area for the next X position. Spectral data is collected during the constant velocity period 202 such that shifts in the charge across the CCD at equally spaced intervals will ensure that each element 104 of the CDD 103 collects data for light scattered from equal length regions on the sample 102.

It will be understood that modifications and alterations can be made to the above described embodiments without departing from the invention as defined in the claims. For example, the light profile that illuminates the sample may have a different shape, such as a spot focus.

1. A spectroscopy apparatus comprising:
a light source for generating a light profile on a sample;
a photodetector having at least one photodetector element for detecting characteristic light generated from interaction of the sample with light from the light source;
a stage for supporting the sample, the stage being movable relative to the light profile;
a stage controller configured to control relative movement of the stage and the light profile; and
a processor configured to:
communicate with the stage controller cause the stage controller to move the light profile relative to the sample in a predetermined continuous motion;
control the photodetector such that the at least one photodetector element records a plurality of spectral values during the predetermined continuous motion, each spectral value being recorded for a corresponding sampling interval;
read out one of the spectral values from the photodetector synchronously with recording another of the spectral values with the at least one photodetector element; and
associate each spectral value with a corresponding given region on the sample predicted to have generated the characteristic light, the given region being extrapolated from (i) a known position of the stage relative to the light profile at a different time to when the spectral value was recorded by the at least one photodetector element, (ii) the predetermined continuous motion between the sample and the light profile, and (iii) a size of the sampling interval.

2. The spectroscopy apparatus according to claim 1, wherein the processor is configured (i) to communicate with the stage controller to cause the stage controller to control movement of the stage relative to the light profile such that, during a measuring period, the stage moves relative to the light profile at a constant velocity and (ii) to control the photodetector such that the photodetector element records the spectral values at equally spaced time intervals during the measuring period.

3. The spectroscopy apparatus according to claim 1, wherein:
the processor is configured to communicate with the stage controller to cause the stage controller to control at least one of the stage and the light profile to be accelerated up to a constant velocity during an acceleration period, and
the processor is configured to control the photodetector to begin recording the spectral values for the characteristic light after the end of the acceleration period.

4. The spectroscopy apparatus according to claim 3, wherein the processor is configured to identify an initial point to be sampled and to communicate with the stage controller to cause the stage controller to control at least one of the stage and the light profile to be set in motion from a position in which the light profile is set back from an intercept position, in which the initial point is illuminated by the light profile to generate characteristic light on the photodetector element, such that the acceleration period has ended by the time the initial point is in the intercept position.

5. The spectroscopy apparatus according to claim 1, wherein the predetermined continuous motion is a preset acceleration profile of at least one of the stage and the light profile and/or a preset velocity profile of at least one of the stage and the light profile.

6. The spectroscopy apparatus according to claim 17, wherein the processor is configured to determine velocity of the stage from the positions detected by the sensor and use the determined velocity to determine the time at which each given region on the sample is illuminated by the light profile to generate characteristic light on the at least one photodetector element.

7. The spectroscopy apparatus according to claim 6, wherein the processor is configured to determine an acceleration of the stage from the determined velocity and use the determined acceleration to determine the time at which a given region on the sample is illuminated by the light profile to generate characteristic light on the at least one photodetector element.

8. The spectroscopy apparatus according to claim 7, wherein the processor is configured to update a time for initiating the photodetector based upon at least one of the determined velocity and acceleration.

9. The spectroscopy apparatus according to claim 17, wherein the sampling intervals during which the at least one photodetector element records the spectral value is shorter than a detection time interval between which detected positions of the stage are reported to the processor from the sensor.

10. The spectroscopy apparatus according to claim 1, wherein:
the photodetector comprises a photodetector timer, and
the at least one photodetector element is arranged to record spectral values at times based upon signals from the photodetector timer.

11. The spectroscopy apparatus according to claim 10, wherein the processor is configured to activate the photodetector timer at a time the stage is predicted to be at a predetermined position relative to the light profile.

12. The spectroscopy apparatus according to claim 11, further comprising a motor for driving the stage, the stage controller controlling a speed of the motor based upon signals from the photodetector timer.

13. A method of carrying out spectroscopy on a sample, the method comprising:
moving the sample relative to a light profile in a predetermined continuous motion such that the light profile successively illuminates a plurality of given regions on the sample;
detecting, with a photodetector element of a photodetector, characteristic light generated from the given regions through interaction of the sample with light forming the light profile such that the photodetector element records a plurality of spectral values during the predetermined continuous motion, each spectral value being recorded for a corresponding sampling interval;
reading out one of the spectral values from the photodetector synchronously with recording another of the spectral values with the photodetector element; and
associating each spectral value with a corresponding given region on the sample predicted to have generated the characteristic light, the given region being extrapolated from (i) a known position of the stage relative to the light profile at a different time to when the spectral value was recorded by the photodetector element, (ii) the predetermined continuous motion between the sample and the light profile, and (iii) a size of the sampling intervals.

14. A data carrier having instructions stored thereon that, when executed by a processor of a spectroscopy apparatus, cause the processor to control the spectroscopy apparatus to carry out the method according to claim 13.

15. The spectroscopy apparatus according to claim 3, wherein:
the photodetector comprises a two-dimensional array of photodetector elements in rows and columns,
a dispersive element disperses a spectrum of light from the given region across one of the rows of photodetector elements,
the or a further processor is arranged to control the photodetector to shift data from a first photodetector element of a first row of the photodetector to a photodetector element of an adjacent row of the photodetector such that charge accumulates across the photodetector elements, the shifting of charge occurring at intervals determined from the constant velocity of the stage and/or the light profile.

16. The spectroscopy apparatus according to claim 15, further comprising a sensor for detecting positions of the stage, wherein the intervals are such that a rate charge is shifted between the first photodetector element and the adjacent photodetector element of the adjacent row is higher than a rate at which detected positions are detected by the sensor.

17. The spectroscopy apparatus according to claim 1, further comprising a sensor for detecting positions of the stage, wherein the known position is a position detected by the sensor.
